(19) United States
(12) Patent Application Publication
(10) Pub. No.: US 2014/0019871 A1
(43) Pub. Date: Jan. 16, 2014

(54) Systems, Apparatuses, Methods and Computer Executable Code for Providing Interactive Friends and/or Contacts Graphic User Interfaces

(71) Applicant: LIVE LENS LTD., Tel Aviv (IL)

(72) Inventors: Max Eitan Bluvband, Gibton (IL); Shahar Hajdu, Givataim (IL)

(21) Appl. No.: 13/939,226

(22) Filed: Jul. 11, 2013

Related U.S. Application Data
(60) Provisional application No. 61/670,684, filed on Jul. 12, 2012.
(60) Provisional application No. 61/726,591, filed on Nov. 15, 2012.

(51) Int. Cl. G06F 3/0484

(52) U.S. Cl. CPC G06F 3/04842
USPC 715/739

(57) ABSTRACT

The present invention includes systems, apparatuses, methods and computer executable code for providing interactive friends and/or contacts graphic user interfaces (GUI). According to some embodiments of the present invention, there may be provided an Interactive Friends and/or Contacts Interfacing Module (IFI) residing within or otherwise functionally associated with a computational device, which computational device includes a friends or contacts functionality (e.g. a cellular phone). An IFI may be adapted to retrieve contact/friend data and provide a user of a mobile phone with an interactive display of contact/friends lists, including data relating to the contacts/friends (e.g. online status) in graphic form and control elements for accessing actions relating to the listed contacts/friends.

### PRIORITY CLAIMS

The present application claims priority from U.S. Provisional Patent Application No. 61/670,684, titled: “Systems, Apparatuses, Methods and Computer Executable Code for Providing an Interactive Friends and/or Contacts Graphic User Interface”, filed by the inventors of the present application on Jul. 12, 2012, and from U.S. Provisional Patent Application No. 61/726,591, titled: “Methods, Circuits, Apparatuses, Systems and Associated Computer Executable Code For Viewing/Browsing Video Content and Providing Real-Time User Feedback to Same”, filed by the inventors of the present application on Nov. 15, 2012, both of which are hereby incorporated by reference into the present application in their entirety.

### FIELD OF THE INVENTION

The present invention is generally related to the field of human-machine interfaces. More specifically, the present invention is related to systems, apparatuses, methods and computer executable code for providing interactive friends and/or contacts graphic user interfaces.

### BACKGROUND

Over the past couple decades the use of mobile communication devices has spread like wildfire throughout human civilization. The permeation of these devices into human society has been so complete that nearly every individual on the planet now carries a mobile communication device. As mobile devices became more and more common their sophistication has advanced in leaps and bounds, such that nowadays most modern mobile devices provide all the functionalities of a home computer, including multimedia and data networking.

These advances in mobile technology alongside its evergrowing use have produced an endless plethora of social networking platforms and communication channels. Throughout the world people use these platforms to share their everyday experiences, thoughts and interests with each other. Platforms such as Facebook and Instagram have become so popular that it is now extremely difficult to find an individual who is not at least a semi-active member, whereas many are extremely active and even continuously monitoring their profiles, posting and “liking”.

In light of these developments, users now have numerous ways in which they communicate with their contacts through their mobile devices. Further. there is also far more data relating to these contacts available to a user via data networks. Accordingly, there has arisen a need to develop more sophisticated user interfaces for presenting lists of user contacts to users of communication devices. These new user interfaces need to provide more data relating to each contact listed and allow more functionalities or easier access to existing functionalities in relation to these contacts. At the same time, esthetics and compactness of these interfaces are also important factors to their users.

### SUMMARY OF THE INVENTION

The present invention includes systems, apparatuses, methods and computer executable code for providing interactive friends and/or contacts graphic user interfaces (GUI). According to some embodiments of the present invention, there may be provided an interactive Friends and/or Contacts Interfacing Module (hereinafter referred to as an: “IFI”) residing within or otherwise functionally associated with a computational device, which computational device includes a friends or contacts functionality (e.g. a cellular phone). An IFI may be adapted to retrieve contact/friend data and provide a user of a mobile phone with an interactive display of contact/friends lists, including data relating to the contacts/friends (e.g. online status) in graphic form and may further provide control elements for accessing actions relating to the listed contacts/friends.
Throughout this disclosure, for the sake of convenience and clarity, embodiments will be described in relation to a mobile phone. it should be understood, however, that the present invention is equally implementable in any computational device (e.g. a personal computer, laptop, digital telephone, etc.) and all descriptions herein should be understood to include such implementations.

According to some embodiments, an IFI may be functionally associated with a friends and/or contacts list residing within a mobile phone, an application including such a list operating on the mobile phone a contact/friends list residing on a remote server accessible from the phone and/or a combination thereof. The IFI may be adapted to retrieve from the device, application and/or server, possibly via an appropriate application programming interface (API), the data contained within the list and/or associated with contacts listed therein, which data may comprise: a graphic representation of each contact/friend (e.g. a profile picture), a title of each contact/friend (e.g. a name) an identifier for the contact/friend, other data relating to the contact/friend contained in the list (e.g. phone number, address, association with a group, current geographical location, etc.), a current status of the contact/friend (e.g. online, offline, etc.) and/or any other data relating to the contacts/friends.

According to some embodiments, an IFI may be further adapted to provide upon a display of the mobile phone an interactive GUI of the contact/friend list or lists (hereinafter this GUI is referred to as: “the Contact GUI” or “CGUI”). The CGUI may include a collage/matrix of the retrieved images representing the contacts/friends contained in the list, wherein each image may be adjacent to the next (i.e. touching the next image) and may further be adjacent to the image below and/or beneath it. The CGUI may further include a title of each image (e.g. the contact/friend name), overlaid on, directly adjacent to or otherwise associated with the image it is a title of. According to further embodiments, a CGUI may further present to the user in graphic form data relating to each of the displayed contact/friend images (e.g. online status). According to some embodiments, the additional data, or portions thereof, may be presented to the user graphically, e.g. by increasing/decreasing the brightness/lighting of one or more of the contact/friend images (e.g. images of contacts/friends currently online may be brighter than images of contacts/friends not currently online), adjusting the coloring, sharpness or contrast of one or more of the contact/friend images (e.g. images of contacts/friends currently online may be in color while other images may be B&W, or in sharper contrast, etc.), grouping the images to present the data (e.g. images of contacts belonging to a particular group may be placed in a specific area of the CGUI), adjusting the shape of a contact representation (e.g. images of contacts having a particular characteristic may be hexagonal, triangular, elongated, etc.) and/or any other graphic representation of data. According to some further embodiments, a contact for which an image is not available may be displayed with a generic image or other graphic representation.

According to further embodiments, an IFI CGUI may include options for a user to input sorting and/or filtering instructions to the IFI. Upon receiving such instructions an IFI may rearrange the images contained with the CGUI based on the requested sorting and/or filtering. According to yet further embodiments, an IFI may be adapted to automatically and/or upon user request, save requested filtering and/or sorting requests such that in future instancements of the IFI the CGUI may be initially presented according to the saved filtering and/or sorting.

According to some embodiments, each image presented in the CGUI may function as a control element, such that when a user selection device (e.g. touch screen, mouse, etc.) is actuated on the image an action may be performed in relation to the associated contact (e.g. a call to the contact/friend may be initiated). According to further embodiments, different actuations performed by a user upon the CGUI may result in different actions being performed in relation to the contact with which the actuation is associated. For example, a left click upon the image of a contact may initiate a call to the contact, a right click may result in a SMS message window opening with the contact included as a addressee and a combination right and left click on the image of a contact may result in further details relating to the contact being displayed. According to further embodiments, a CGUI may include control elements or options to manipulate the display (e.g. scroll down, rotate, etc.), and/or change the display format (e.g. switch from square to circle format).

It should be understood that an IFI may operate within or in parallel to other applications, such that the IFI merely alters the contact interface of the application without affecting other operations of the application or exiting the application framework. For example, an IFI may interact with a facebook application, such that the IFI modifies the contact GUI of the facebook application without affecting other aspects of the operation of the facebook application.

According to some embodiments of the present invention there may be provided a communication device comprising:

a display;
an interactive contact interfacing module adapted to:
(a) retrieve a list of contacts;
(b) retrieve data sets including data associated with one or more contacts of the list of contacts, wherein the data associated with each contact of the one or more contacts may include: (1) a contact title, (2) a contact graphical representation, and/or (3) an online status;
(c) render upon the display a contact graphic user interface (CGUI) including control elements, each control element being associated with one of the one or more contacts, and each skinned with the graphical representation of the respective contact;
wherein the rendering may include graphically modifying in brightness, contrast or focus at least one of the graphical representations as a function of one or more dynamic characteristics of contacts associated with the at least one of the graphical representation.

According to further embodiments, graphically modifying in brightness, contrast or focus may include modifying in brightness as a function of a first characteristic of the one or more dynamic characteristics of contacts associated with the at least one of the graphical representations and modifying in contrast or focus as a function of a second characteristic of the one or more dynamic characteristics of contacts associated with the at least one of the graphical representations, distinct from the first characteristic.

According to certain embodiments, rendering may include graphically modifying in brightness graphical representations of contacts currently online. According to such embodiments, rendering may further include modifying in contrast or focus at least one of the graphical representations as a function of one or more dynamic characteristics of contacts associated with the at least one of the graphical representations.

According to further embodiments, selection of graphical representations to be modified may be based on user defined parameters, which may be selectable via the CGUI.

According to further embodiments, rendering may further include arranging the control elements within the CGUI based on geographical locations of the one or more contacts.

According to further embodiments, rendering may further include rendering an image representative of a video clip in association with one or more of the control elements, wherein each given image representative of a given video clip may be a control element associated with the given video clip.

According to further embodiments, the control elements may be arranged in a collage with each skin contiguous to neighboring skins.

According to some embodiments of the present invention there may be provided a method of generating contact graphical user interfaces (CGUI's), the method comprising:
a. retrieving a list of contacts from a data storage;
b. retrieving data sets including data associated with one or more contacts of the list of contacts, wherein the data associated with each contact of the one or more contacts may include: (1) a contact title, (2) a contact graphical representation, and/or (3) data indicative of one or more dynamic contact characteristics; and
c. rendering upon a display a contact graphic user interface (CGUI) including control elements, each control element being associated with one of the one or more contacts and skinned with the graphical representation of the respective contact;
wherein said rendering may include graphically modifying in brightness, contrast or focus at least one of the graphical representations as a function of one or more dynamic characteristics of contacts associated with the at least one of the graphical representations.

According to further embodiments graphically modifying in brightness, contrast or focus may include modifying in brightness as a function of a first characteristic of the one or more dynamic characteristics of contacts associated with the at least one of the graphical representations and modifying in contrast or focus as a function of a second characteristic of the one or more dynamic characteristics of contacts associated with the at least one of the graphical representations, distinct from the first characteristic.

According to further embodiments, selection of graphical representations to be modified may be based on user defined parameters, which may be selectable via the CGUI.

According to further embodiments, rendering may further include arranging the control elements within the CGUI based on geographical locations of the one or more contacts.

According to further embodiments, rendering may further include rendering an image representative of a video clip in association with one or more of the control elements, wherein each given image representative of a given video clip may be a control element associated with the given video clip.

According to further embodiments, the control elements may be arranged in a collage with each skin contiguous to neighboring skins.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof. may best be understood by reference to the following detailed description when read with the accompanying drawings in which:

FIG. 1: is an illustration of an exemplary CGUI in grid form, in accordance with some embodiments of the present invention;

FIG. 2: is an illustration of an exemplary CGUI in circle form, in accordance with some embodiments of the present invention;

FIG. 3: is an illustration of an exemplary CGUI in a “Tree” form, in accordance with some embodiments of the present invention;

FIG. 4: is an illustration of an exemplary CGUI in Trapezoid form, in accordance with some embodiments of the present invention;

FIG. 5: is an illustration of an exemplary 3D type CGUI in cube format, in accordance with some embodiments of the present invention;

FIG. 6: is an illustration of an exemplary 3D type CGUI in multiple cube format, in accordance with some embodiments of the present invention;

FIG. 7: is an illustration of an exemplary CGUI displayed aside a video display, in accordance with some embodiments of the present invention;

FIG. 8: is an illustration of an exemplary CGUI in grid form including a representation of a video clip associated with each contact/friend aside the contact's/friend's graphical representation, all in accordance with some embodiments of the present invention;

FIG. 9: is an illustration of an exemplary CGUI in a “Tree” form, wherein data relating to the contacts/friends is also represented by a shape of the image representing the contact/friend, all in accordance with some embodiments of the present invention;

FIG. 10: is a block diagram of an exemplary mobile device including an IFI, in accordance with some embodiments of the present invention;

FIG. 11: is an exemplary screenshot type illustration of an exemplary CGUI in grid form, corresponding to FIG. 1, in accordance with some embodiments of the present invention;

FIG. 12: is an exemplary screenshot type illustration of an exemplary CGUI in circle form, in accordance with some embodiments of the present invention;

FIG. 13: is an exemplary screenshot type illustration of an exemplary CGUI in a “Tree” form, in accordance with some embodiments of the present invention;

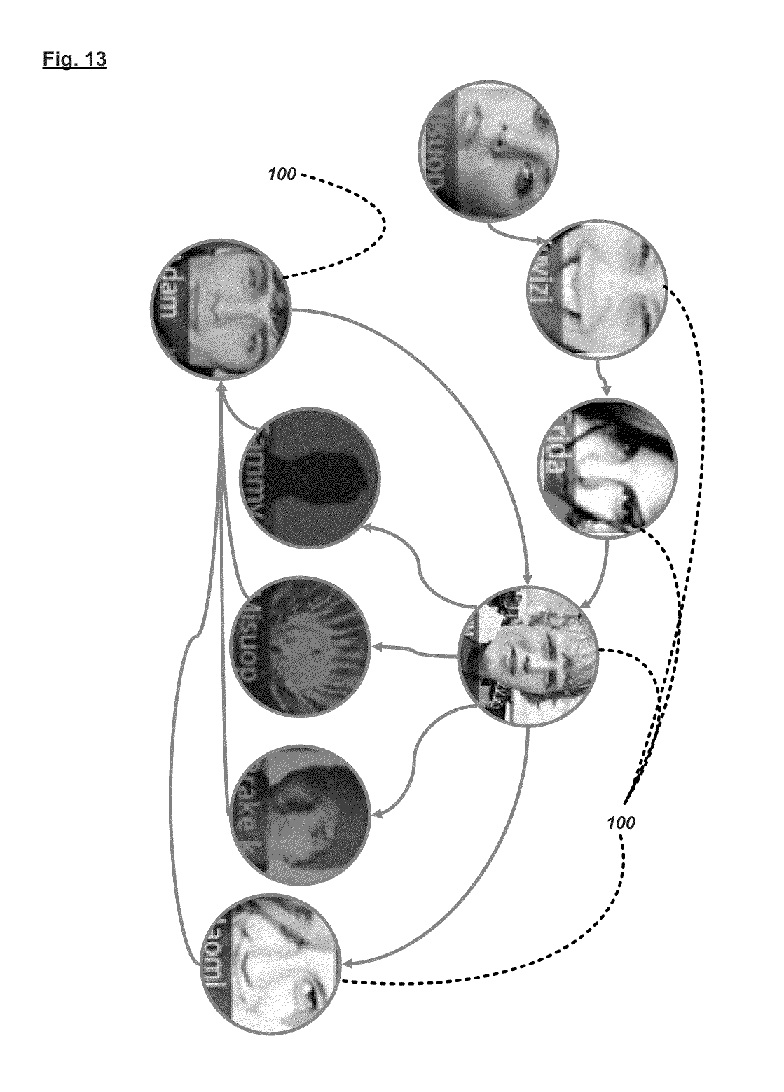

FIG. 14: is an exemplary screenshot type illustration of an exemplary CGUI in Trapezoid form, in accordance with some embodiments of the present invention;

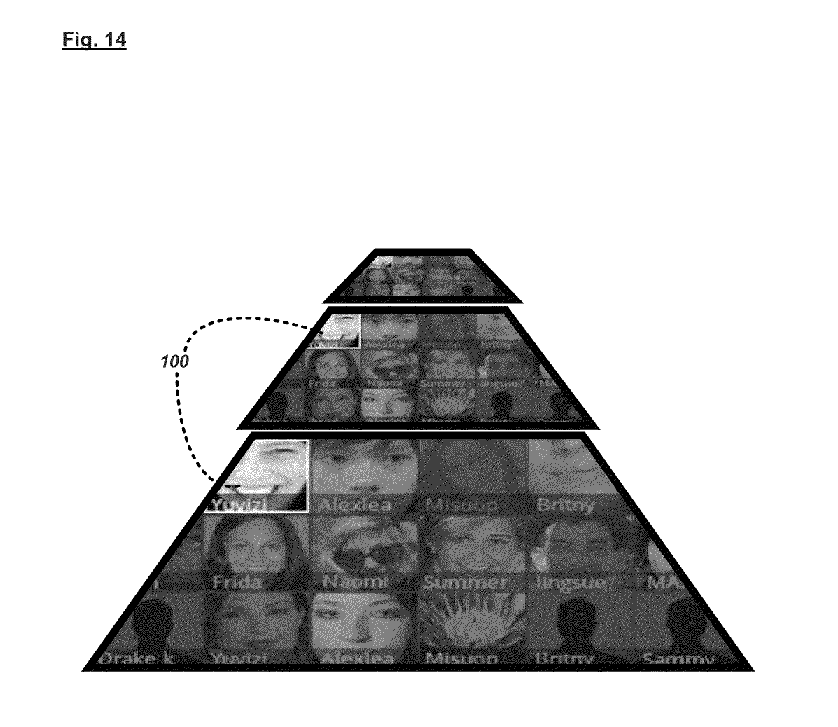

FIG. 15: is an exemplary screenshot type illustration of an exemplary 3D type CGUI in cube format, in accordance with some embodiments of the present invention;

FIG. 16: is an exemplary screenshot type illustration of an exemplary 3D type CGUI in multiple cube format, in accordance with some embodiments of the present invention;

FIG. 17: is an exemplary screenshot type illustration of an exemplary CGUI displayed aside a video display, in accordance with some embodiments of the present invention;

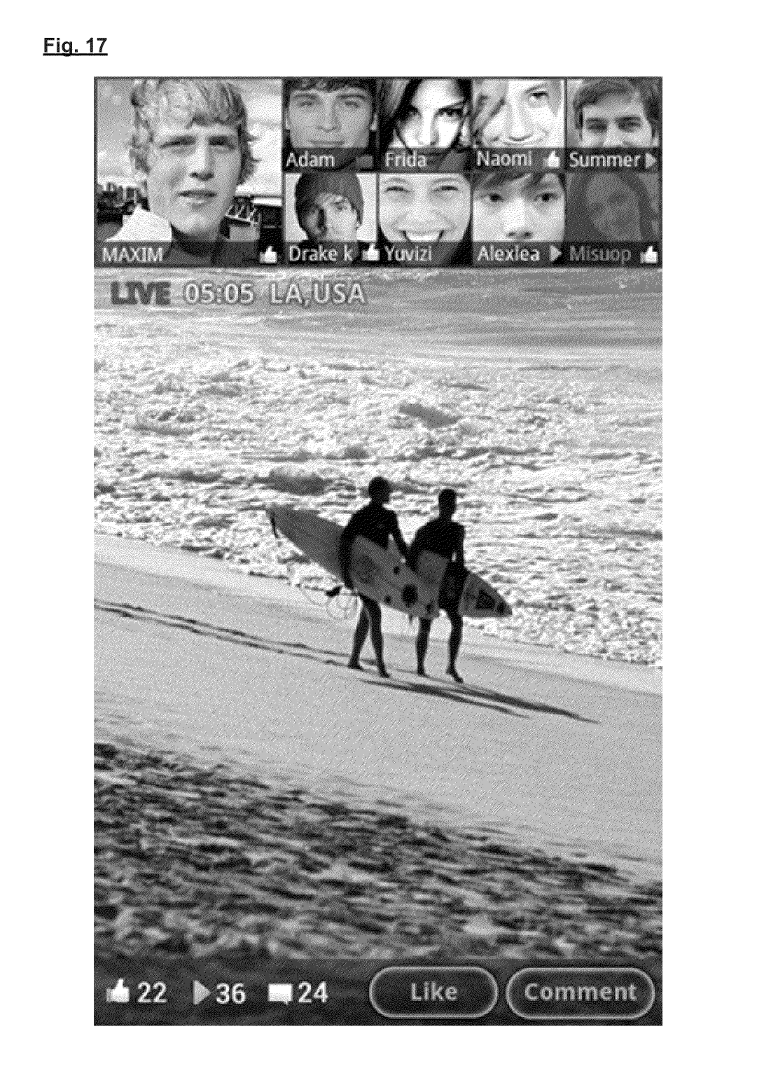

FIG. 18: is an exemplary screenshot type illustration of an exemplary CGUI in grid form including a representation of a video clip associated with each contact/friend aside the contact's/friend's graphical representation, all in accordance with some embodiments of the present invention;

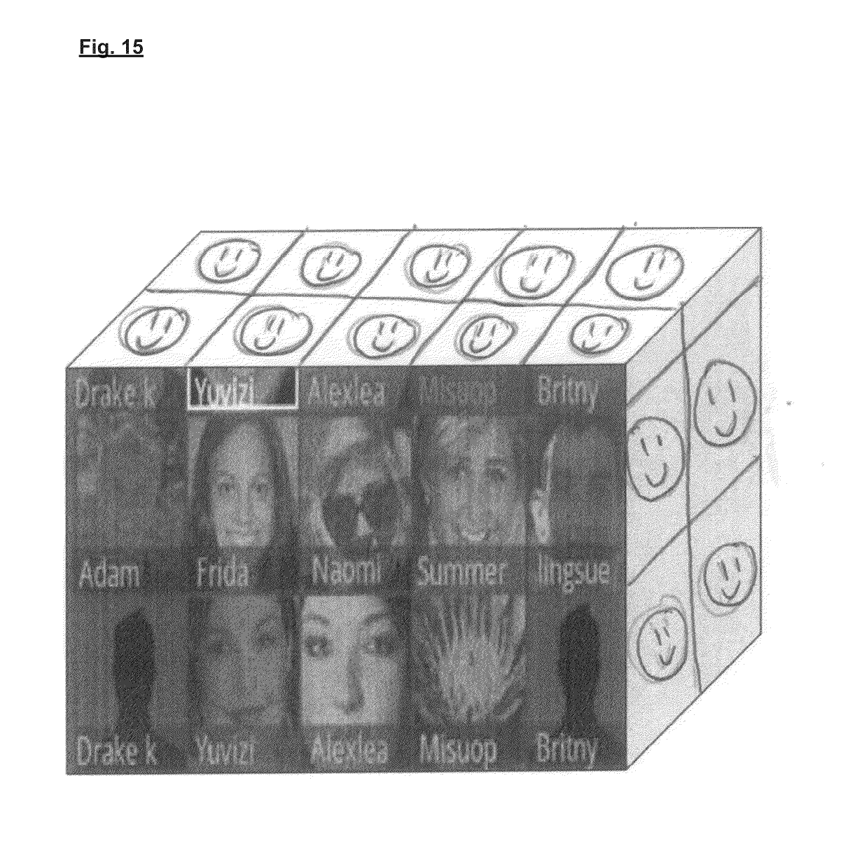

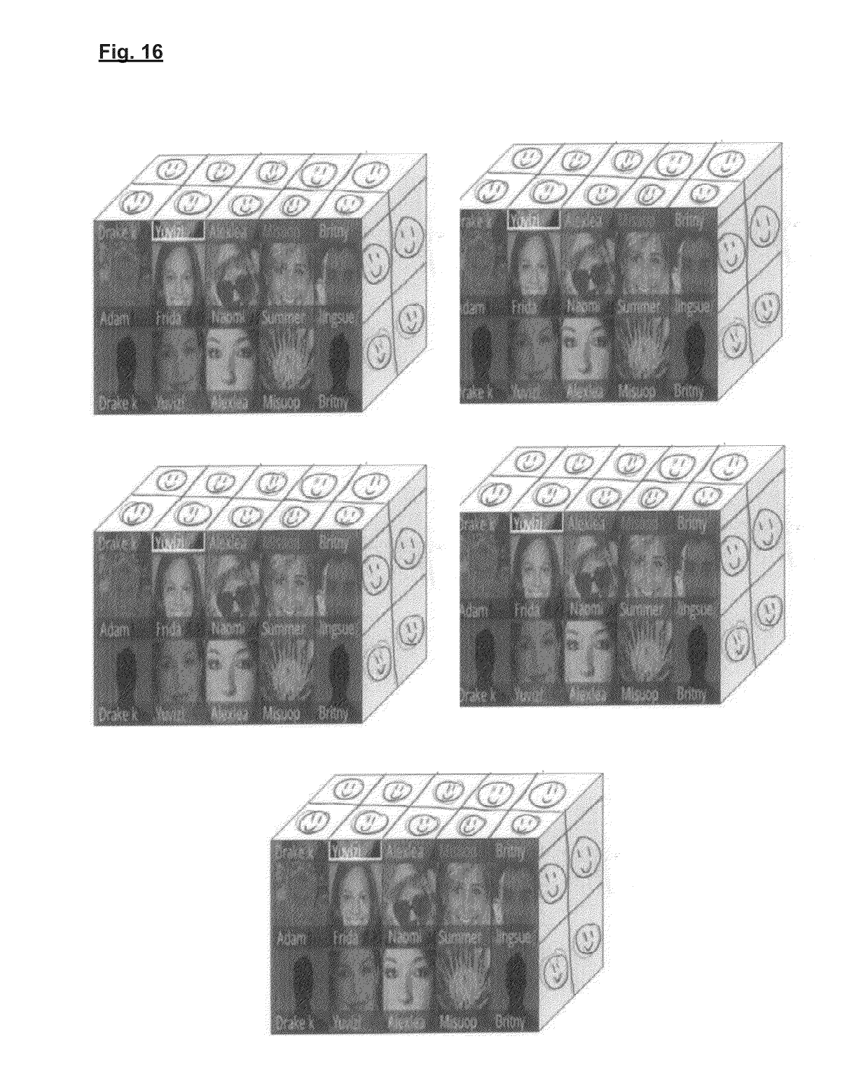

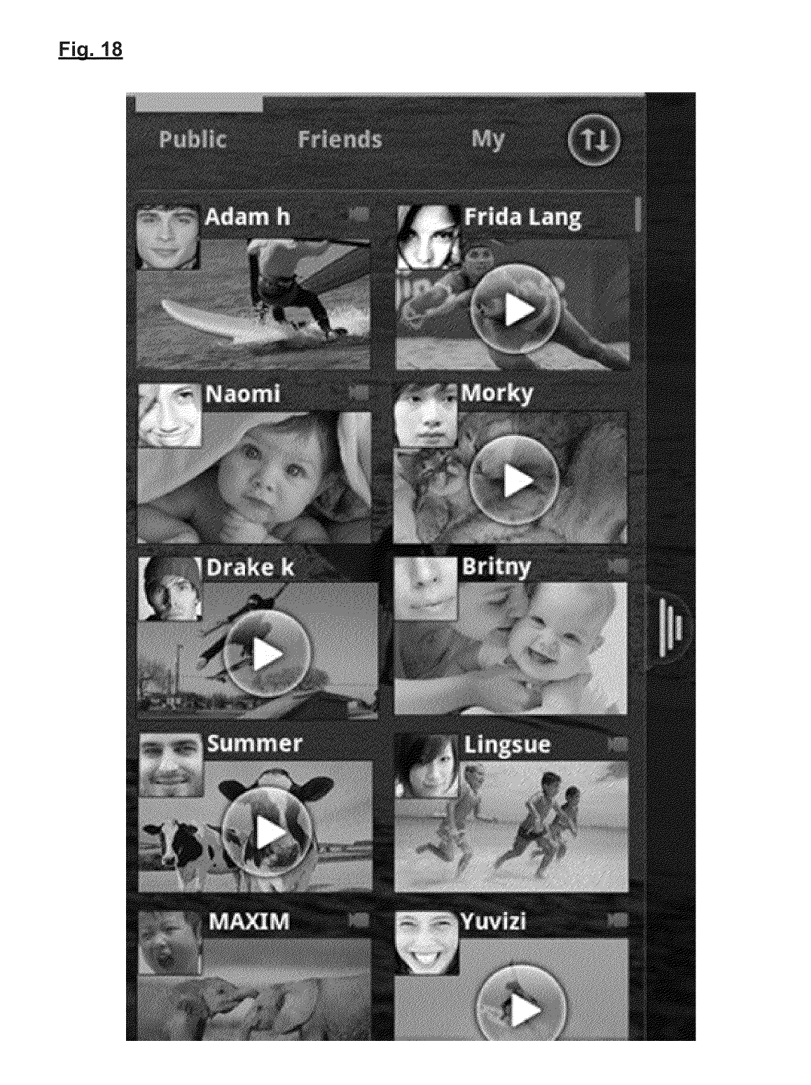

It should be understood that the exemplary names and images presented in the drawings are presented for demonstrative purposes only, and their particular identity and appearance are insignificant beyond demonstrating examples of titles and images associated with contacts/friends. Equally it should be understood that multiple appearances of the same title or image are not intended to represent any correlation between the images and should be viewed as if each title and character/face appearing were distinct. Furthermore, in FIGS. 15-16, exemplary images+titles of contacts in some cases have been replaced with a square including a smiley face in its center. Such representations should be understood to be equivalent to a picture+Title of a contact/friend.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, memory cards (for example SD card), SIM cards, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer, communication device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language or markup language. It will be appreciated that a variety of programming languages or techniques may be used to implement the teachings of the inventions as described herein.

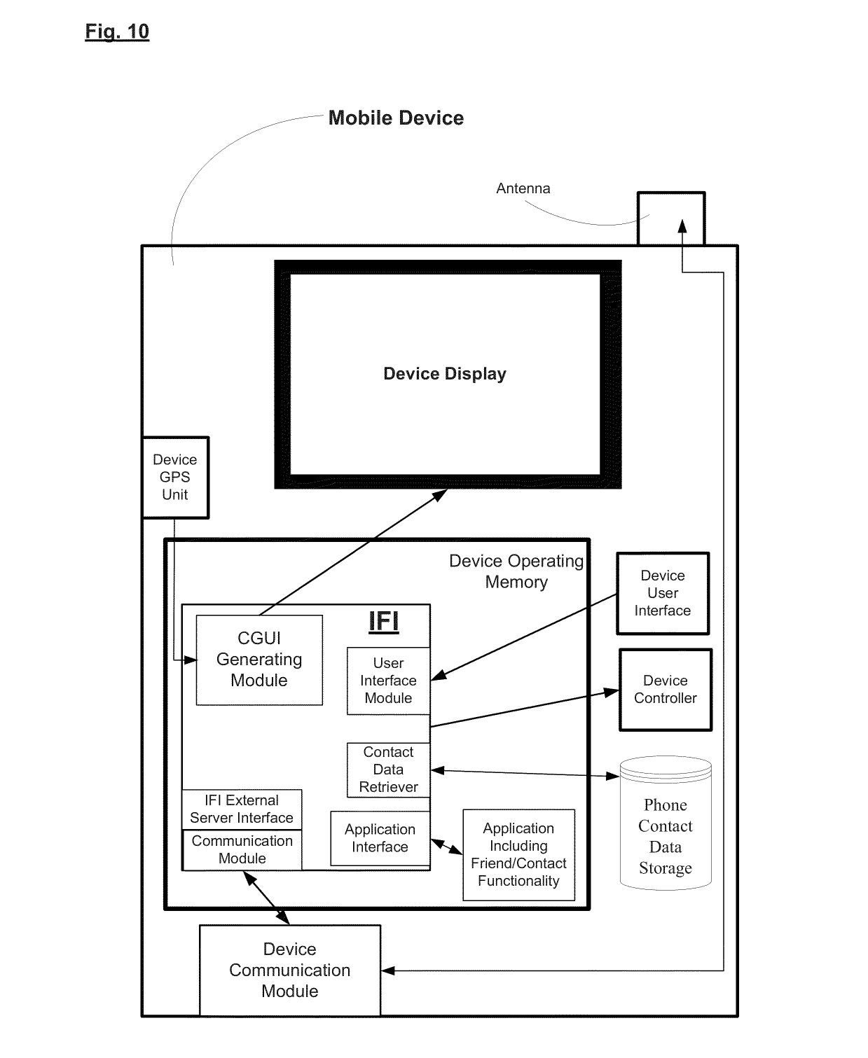

The present invention includes systems, apparatuses, methods and computer executable code for providing interactive friends and/or contacts graphic user interfaces (GUI). According to some embodiments of the present invention, there may be provided an interactive Friends and/or Contacts Interfacing Module (hereinafter referred to as an: “IFI”) residing within or otherwise functionally associated with a computational device, which computational device includes a friends or contacts functionality (e.g. a cellular phone) [an example of a communication device including an IFI is demonstrated by FIG. 10]. An IFI may be adapted to retrieve contact/friend data and provide a user of a mobile phone with an interactive display of contact/friends lists, including data relating to the contacts/friends (e.g. online status) in graphic form and control elements for accessing actions relating to the listed contacts/friends.
Throughout this disclosure, for the sake of convenience and clarity, embodiments will be described in relation to a mobile phone. It should be understood, however, that the present invention is equally implementable in any computational device (e.g. a personal computer, laptop, digital telephone, etc.) and all descriptions herein should be understood to include such implementations.

According to some embodiments, an IFI may be functionally associated with a friends and/or contacts list residing within a mobile phone, an application including such a list operating on the mobile phone a contact/friends list residing on a remote server accessible from the phone and/or a combination thereof. The IFI may be adapted to retrieve from the device, application and/or server, possibly via an appropriate application programming interface (API), the data contained within the list and/or associated with contacts listed therein, which data may comprise: a graphic representation of each contact/friend (e.g. a profile picture), a title of each contact/friend (e.g. a name), an identifier for the contact/friend, other data relating to the contact/friend contained in the list (e.g. phone number, address, association with a group, current geographical location, etc.), a current status of the contact/friend (e.g. online, offline, etc.) and/or any other data relating to the contact/friend.

According to some embodiments, an IFI may be further adapted to provide upon a display of the mobile phone an interactive GUI of the contact/friend list or lists (hereinafter this GUI is referred to as: “the Contact GUI” or “CGUI”). An IFI may be adapted to provide the CGUI upon request by a user and/or automatically whenever such a list is accessed by a user of the device. Furthermore, an IFI may include options for a user to define when the IFI will provide a CGUI and which CGUI to provide each time. For example, a user may define that local contacts, when displayed, will automatically be displayed by the IFI in a CGUI of one sort, whereas facebook contacts, when accessed via a facebook application, will only be displayed by the IFI in a CGUI at the user request and this will be in a different sort of CGUI. In other words, an IFI may be automatically instanced whenever a contact list is displayed on a device it is associated with and/or upon a user activation. Accordingly, an IFI may include appropriate interfacing code to allow it to function within a framework of other applications (e.g. facebook) without interfering with the operation of the relevant application.

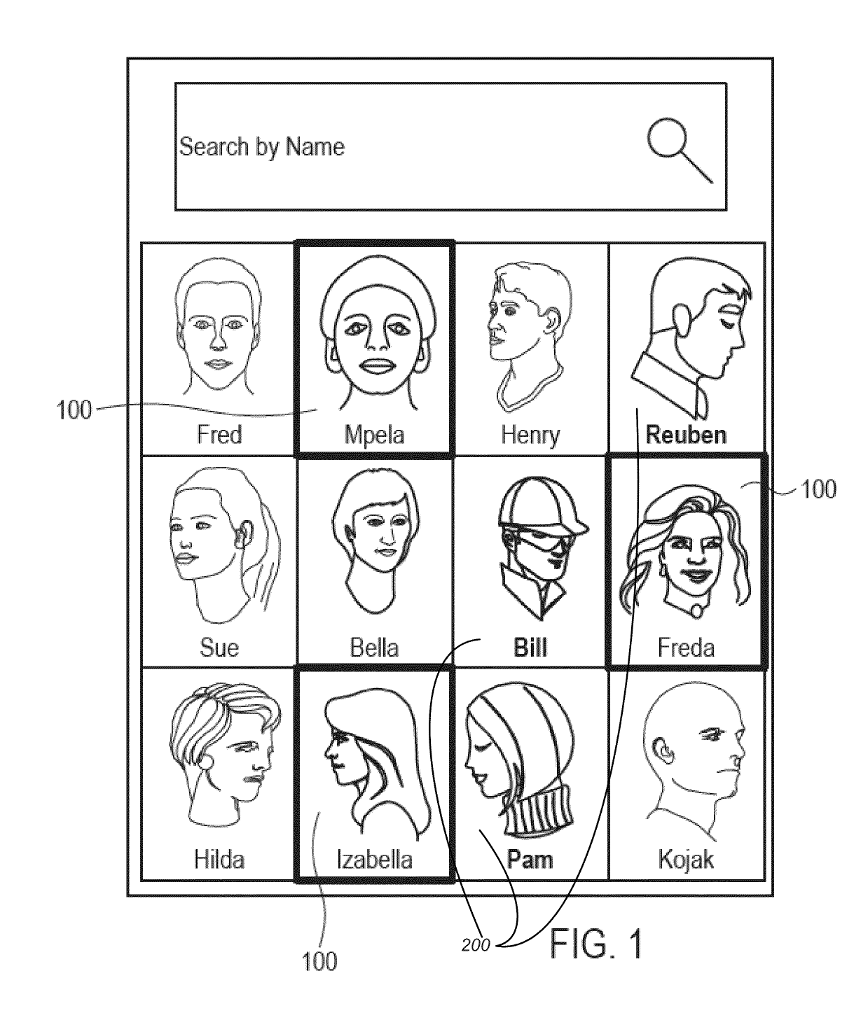

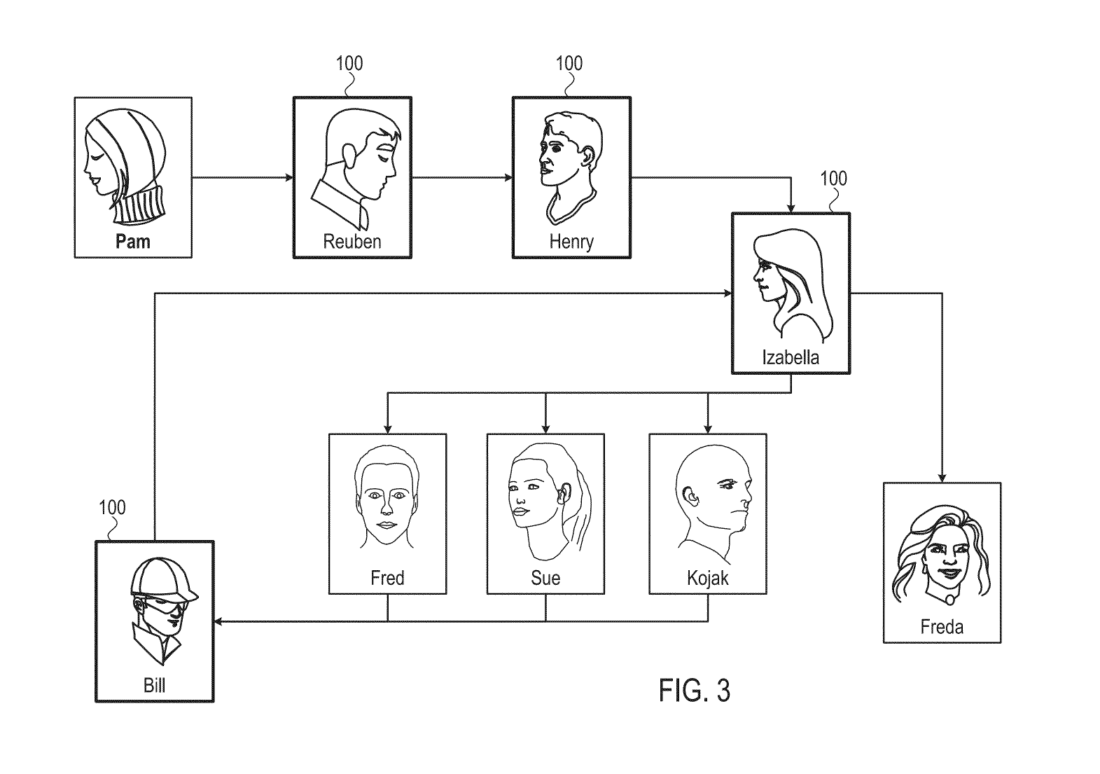

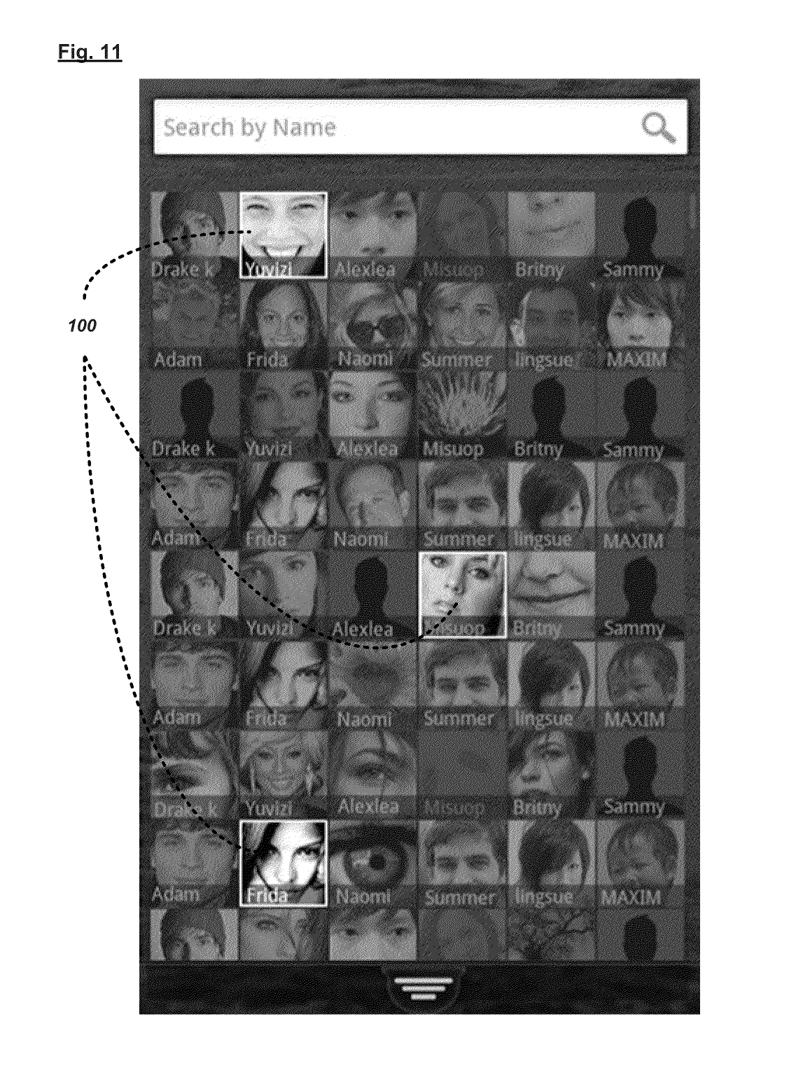

A CGUI may include a collage/matrix of the retrieved images representing the contacts/friends contained in the list [as shown in FIGS. 1-9 & 11-18], wherein each image may be adjacent to the next (i.e. touching the next image) and may further be adjacent to the image below and/or beneath it [as can be seen in FIGS. 1-2, 4-8, 11-12 & 14-18]. The CGUI may further include a title of each image (e.g. the contact/friend name), overlaid on, directly adjacent to or otherwise associated with the image it is a title of. According to further embodiments, images+Titles of contacts/friends may be arranged to show interrelations between the contacts/friends [as shown in FIGS. 3 & 13].

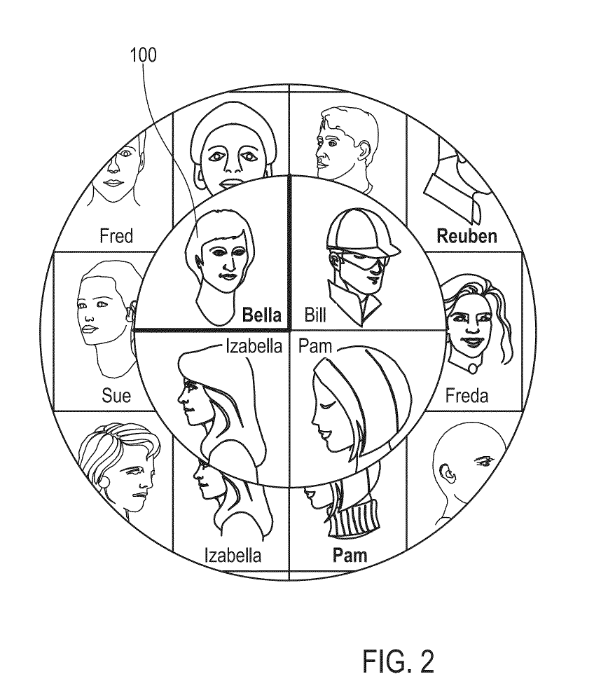

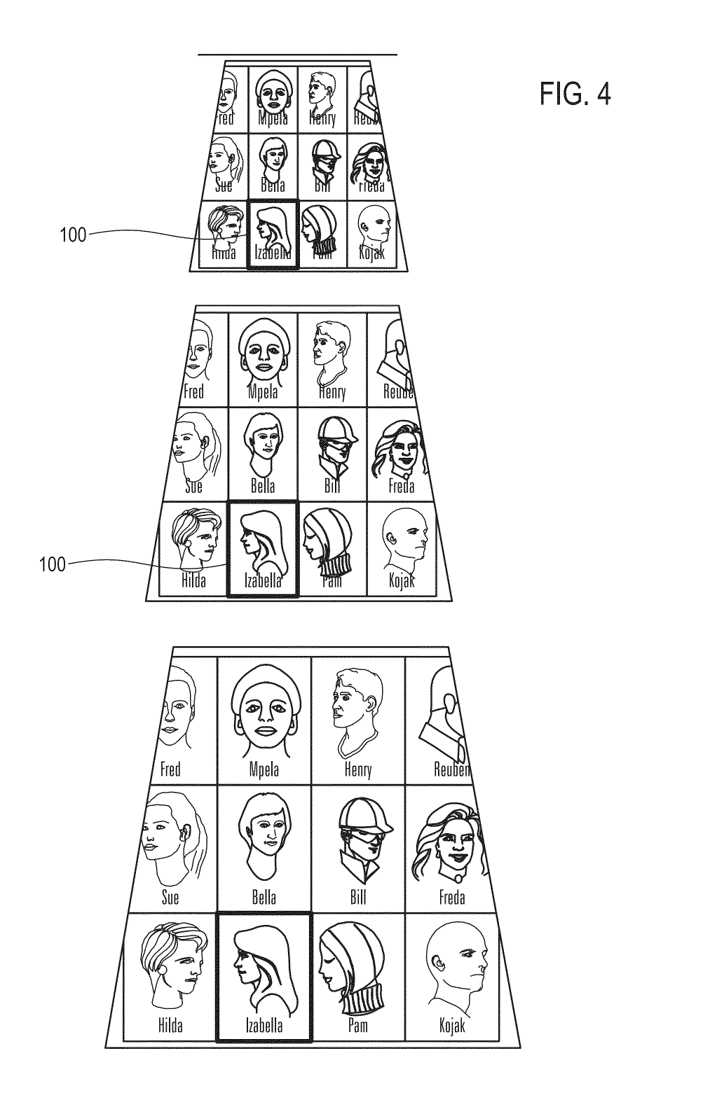

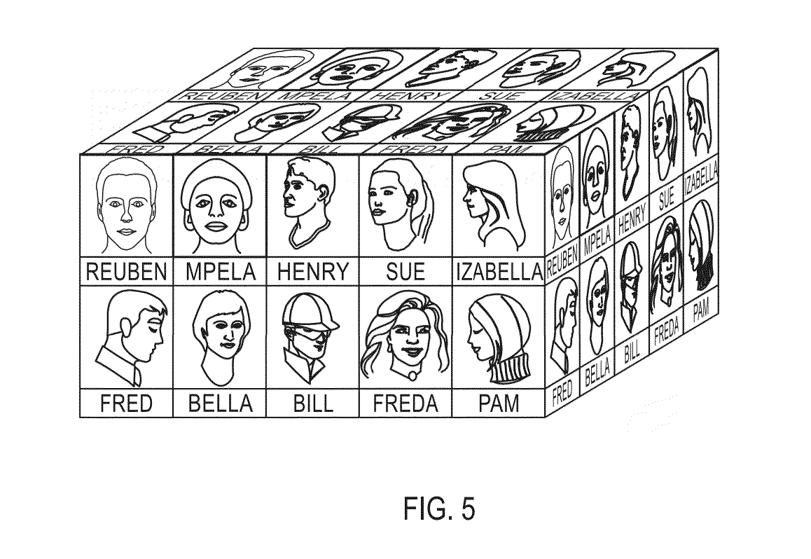

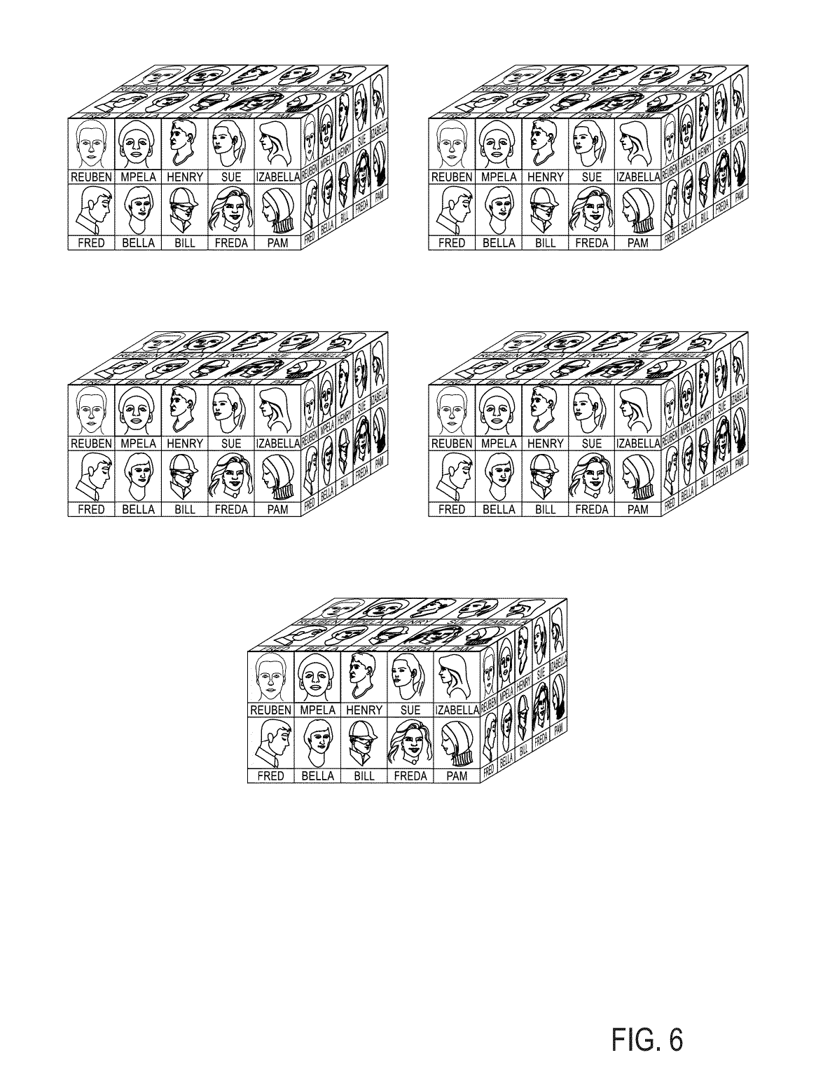

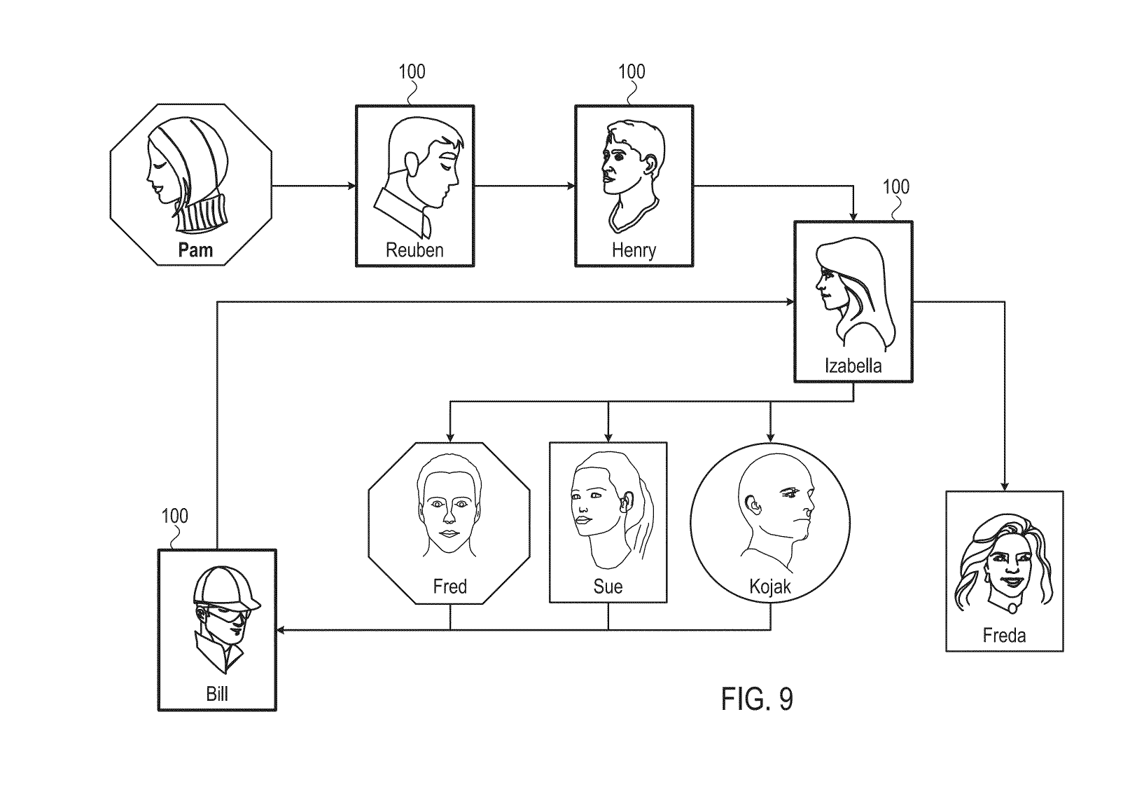

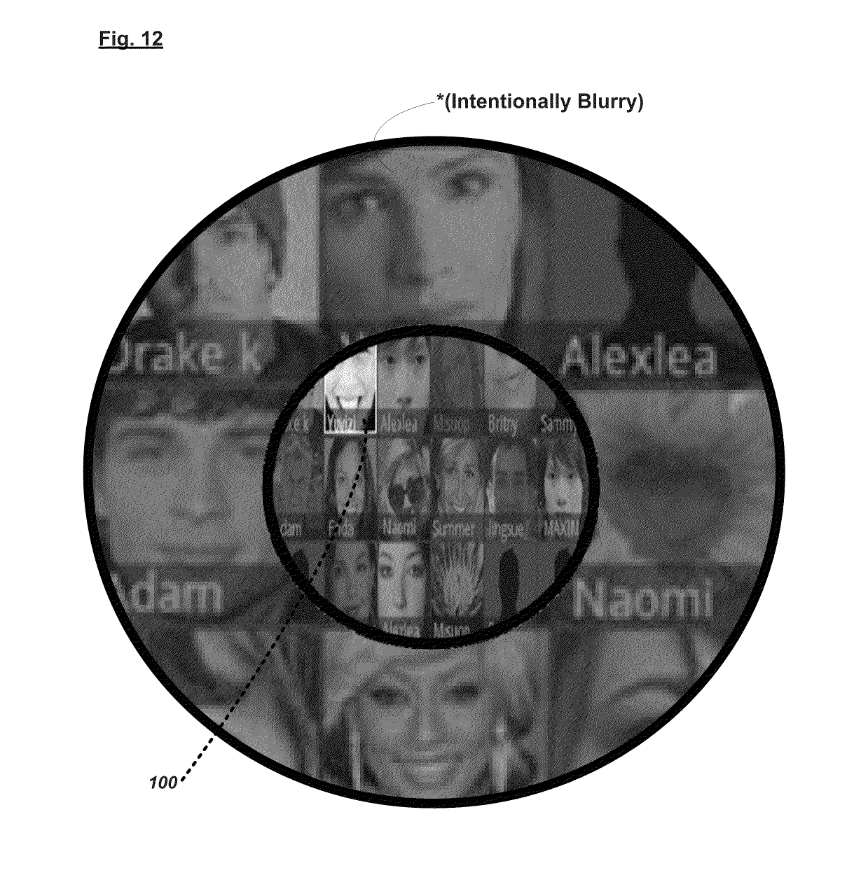

According to some embodiments, a CGUI may further present to the user in graphic form data relating to each of the displayed contact/friend images (e.g. online status). According to some embodiments, the additional data may be presented to the user by:
a. increasing/decreasing the brightness/lighting of one or more of the contact/friend images (e.g. images of contacts/friends currently online may be brighter than images of contacts/friends not currently online) [as shown in the figs by marking 100];
b. adjusting the coloring, sharpness, resolution or contrast of one or more of the contact/friend images (e.g. images of contacts/friends currently online or of a certain group, may be in color while other images may be B&W, or in sharper contrast, etc.) [as shown in FIGS. 1 & 12]. FIG. 1 illustrates this concept. As can be seen, images marked 200 are in sharper contrast than others. Turning to FIG. 12 it can be seen that the inner circle of contacts/friends is in sharper contrast/higher-resolution then the outer circle. It should be understood that the difference in contrast/resolution between the contact/friend images may not be correlated to the circles, such that images of contacts/friends within the same circle or grid may appear in different contrasts/resolutions in order to present data to the user relating to each of the contacts/friends (e.g. currently online contacts/friends may be presented in sharper contrast/higher resolution than other contacts/friends);
c. grouping/arranging the images to present the data (e.g. images of contacts belonging to a particular group may be placed in a specific area of the CGUI). Examples of this concept are presented in FIGS. 2-6 & 12-16, wherein:
   FIGS. 2 & 12 show exemplary CGUIs in which contact/friend images and titles are arranged in circles. In such CGUIs each circle may signify data related to the contacts/friends whose images appear in that circle (e.g. contacts/friends currently within the same geographical area as the user of the mobile phone may appear in an inner circle, contacts currently within the same country but another geographical area in a second circle and those outside the country in an outermost circle).
   FIGS. 3 & 13 show exemplary CGUIs in which contact/friend images and titles are arranged in “Tree” type arrangement. In such a CGUI arrangement and connections may signify data related to the contacts/friends (e.g. contacts/friends may be arranged according to the interconnections between them).
   FIGS. 4 & 14 show exemplary CGUIs in which contact/friend images and titles are arranged in Trapezoids. In such a CGUI each Trapezoid may signify data related to the contacts/friends whose images appear in that trapezoid (e.g. contacts/friends which are family of the user of the mobile phone may appear in one trapezoid, friends in another and work contacts in the third, etc);
   FIGS. 5 & 15 show exemplary 3D CGUIs in which contact/friend images and titles are arranged in cubical arrangement. In such a CGUI each side of the cube may signify data related to the contacts/friends whose images appear on that side (e.g. contacts/friends which are family of the user of the mobile phone may appear on one side, friends on another and work contacts on the third, etc).
   FIGS. 6 & 16 show exemplary 3D CGUIs in which contact/friend images and titles are arranged in multiple cubes. In such a CGUI each cube signify data related to the contacts/friends whose images appear on that cube and each side of each cube may further signify other data related to the contacts/friends whose images appear on that side (e.g. one cube may be comprised of family members, one of friends and one of work contacts, and within each cube the front side may be comprised of contacts/friends frequently contacted, the top side of contacts/friends less frequently contacted and the third side of contacts/friends rarely or never contacted, etc). In such a CGUI, a user may be able to select one of the cubes, in response to which the IFI may present the selected cube alone [as shown in FIG. 5] or centered/enlarged;
d. adjusting shapes of contact representations (e.g. images of contacts having a particular characteristic may be hexagonal, triangular, elongated, etc.) [as shown in FIG. 9]; and/or
e. any other graphic representation of data.

Clearly, combinations of the above described graphical representation of data relating to contacts/friends may be implemented. For example, within a cubicle presentation as described above, particular images of certain contacts/friends may be brighter or in sharper contrast than others, and so on).

According to yet further embodiments, a moving CGUI may be provided. For example, contacts may be arranged on the circumference of a ball shape which rotates around its axis, or a linear configuration which slowly moves from left to right or top to bottom, and so on. In such embodiments, motion of the CGUI may be constant, periodical and/or in reaction to user action (e.g. clicking or mousing over a control element). Further, parameters of motion (e.g. motion speed and direction) may be user selectable.

The above described graphical representations of data (a-e) may be used to represent any form of data relating to contacts/friends. Non-limiting examples of data that may be represented may include: (1) current status of contacts/friends (e.g. currently online or currently available to chat contacts/friends), (2) interests/hobbies of contacts/friends (e.g. contacts interested in surfing), (3) current or permanent geographical location or residence of contacts/friends (e.g. contacts/friends currently within 1 mile of the mobile phone), (4) interrelations between contacts/friends, (5) age, gender, occupation, school, and other personal data of contacts/friends, (6) the time of most recent login to a related service of contacts/friends (e.g. last login to facebook), (7) number of mutual contacts/friends shared by each contact/friend, (8) inclusion of contacts/friends to a particular group (e.g. football team the contacts/friends are a fan of); (9) applications installed in the contacts/friends devices (e.g. play a particular game online, such as “chess master”); and/or (10) any other data relating to contacts/friends.

According to further embodiments, an IFI may be adapted to modify the above described graphical representations of data based on a sorting filter or search requested by the user. For example, based on a user request, images of contacts/friends who are fans of the Atlanta Falcons may be highlighted or otherwise distinguished using the above described graphical representations.

According to further embodiments, an IFI CGUI may include options for a user to input sorting and/or filtering instructions to the IFI. Upon receiving such instructions an IFI may rearrange the images contained with the CGUI based on the requested sorting and/or filtering. According to yet further embodiments, an IFI may be adapted to automatically and/or upon user request, save requested filtering and/or sorting requests such that in future instancements of the IFI the CGUI may be initially presented according to the saved filtering and/or sorting. Similarly, an IFI may provide for a user to select among possible CGUI's and define their parameters. i.e. a user may be able to select the type of graphical representations implemented and/or the data to be represented. According to yet further embodiments, an IFI may be adapted to save multiple profiles of CGUI types and sorting and filtering preferences relating to the CGUI. For example, an IFI may use one sorting and filtering profile for facebook contact listings and a separate sorting and filtering profile for the device contact listings. Equally, different users may each have an profile saved on the device.

According to some embodiments, each image presented in the CGUI may function as a control element, such that when a user selection device (e.g. touch screen, mouse, etc.) is actuated on the image an action may be performed in relation to the associated contact (e.g. a call to the contact/friend may be initiated). According to further embodiments, different actuations performed by a user upon the CGUI may result in different actions being performed in relation to the contact with which the actuation is associated. For example, a left click upon the image of a contact may initiate a call to the contact, a right click may result in a SMS message window opening with the contact included as a addressee and a combination right and left click on the image of a contact may result in further details relating to the contact being displayed. According to further embodiments, a CGUI may include control elements or options to manipulate the display (e.g. scroll down, rotate, etc.), and/or change the display format (e.g. switch from square to circle format). * in this description and accompanying claims, rendering a control element upon a display which appears as an image may be referred to as “skinning” the control element with the image. The image is thus referred to as the “skin” of the control element.

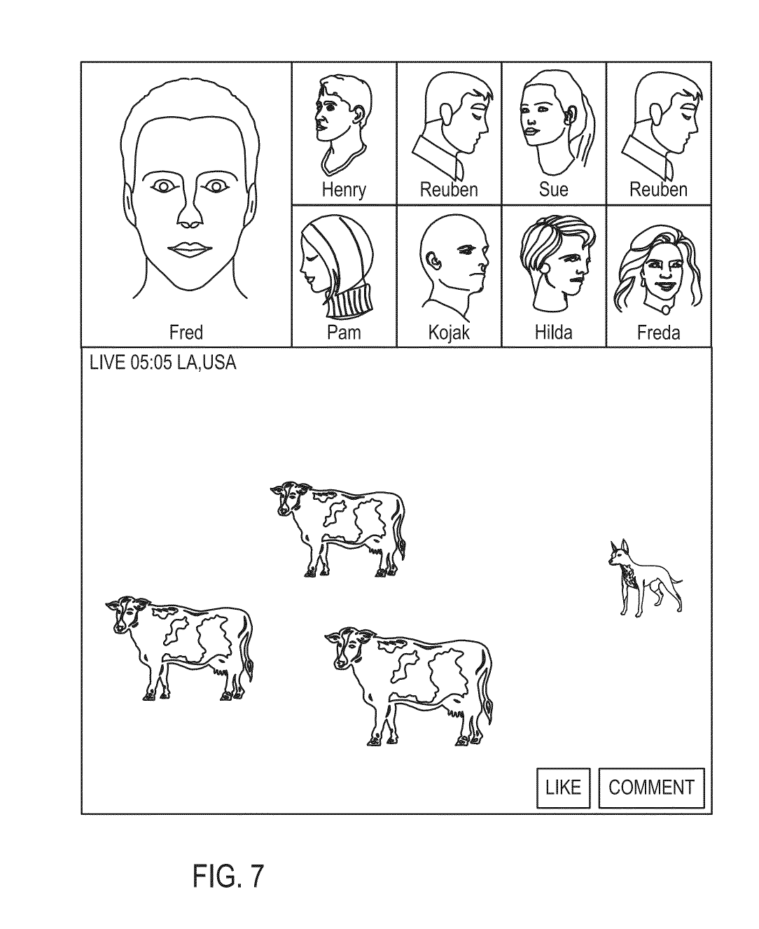

According to further embodiments, an IFI may be adapted to present any of the above mentioned CGUI's aside or upon another display (e.g. a video clip). This concept is exemplified in FIG. 7, which illustrates an exemplary CGUI aside a video clip.

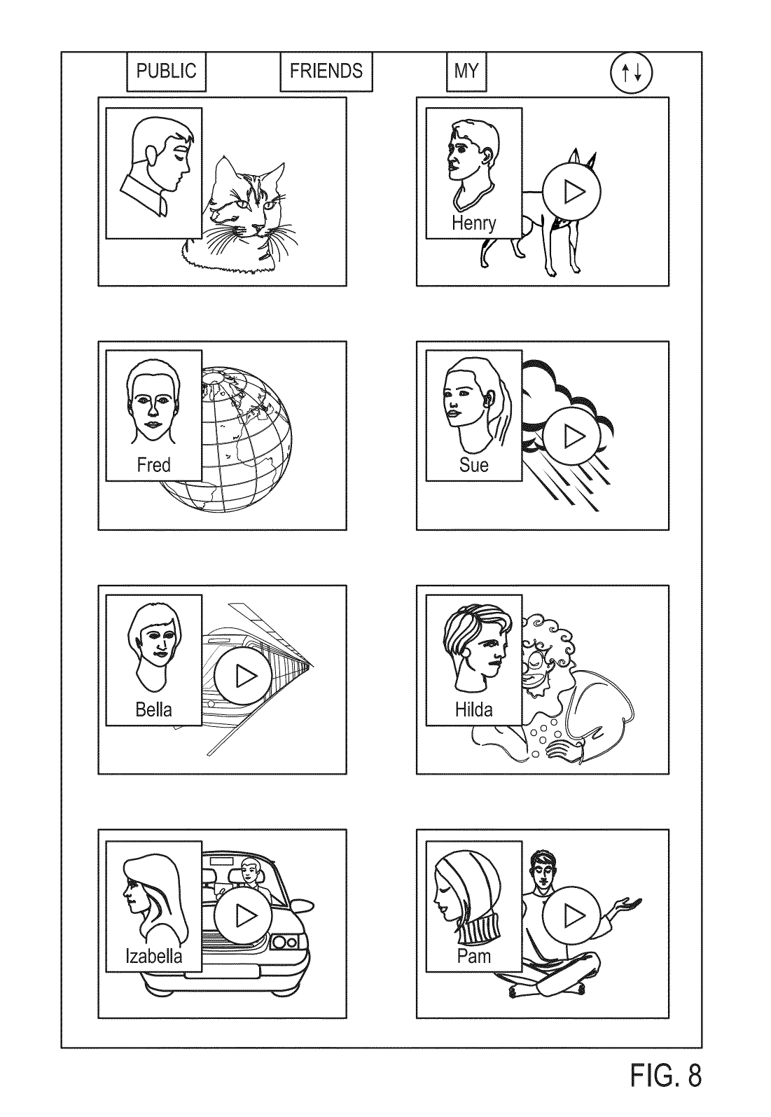

According to yet further embodiments, an IFI may be adapted to present multiple images of each contact/friend. This concept is illustrated in FIGS. 8 & 18. In FIGS. 8 & 18 each contact/friend is represented by both a profile picture and the latest image or videoclip posted by that contact/friend on facebook. Similarly, each contact/friend “square” may include a collage of pictures of that contact/friend.

According to some embodiments, an IFI may be adapted to communicate with an external IFI server adapted to provide, via a distributed data network (e.g. the internet) support and/or communication functionalities to IFI Applications. According to further embodiments, the functionalities of a IFI external server may be performed by modules or servers hosted by, embedded in or otherwise functionally associated with Social Networking Sites, and all descriptions herein relating to an IFI should be understood to apply equally to such embodiments with the relevant modifications.

According to some embodiments, an IFI may be further adapted to determine a geographical location of the mobile phone it is associated with (e.g. may retrieve geo data from a GPS unit of the user device). According to some embodiments, geo data relating to a communication device may be used to organize some of the CGUIs for example, in CGUIs where contacts are arranged based at least partially on physical proximity to the device. According to yet further embodiments, an IFI may be further adapted to retrieve other data relating to a user or device it is associated with from other applications in the device, network resources and/or social networks. This data may be used to properly arrange a CGUI for example, an IFI may retrieve from a social networking application of the user data relating to his/her topics of interest/hobbies, which may then allow the IFI to properly arrange a CGUI to which the data is relevant.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A communication device comprising:
a display; and
an interactive contact interfacing module adapted to:
(d) retrieve a list of contacts;
(e) retrieve data sets including data associated with one or more contacts of the list of contacts, wherein the data associated with each contact of the one or more contacts includes: (1) a contact title, (2) a contact graphical representation, and (3) data indicative of one or more dynamic contact characteristics; and
(f) render upon said display a contact graphic user interface (CGUI) including control elements, each control element being associated with one of the one or more contacts, and each skinned with the graphical representation of the respective contact;
wherein said rendering includes graphically modifying in brightness, contrast or focus at least one of the graphical representations as a function of one or more dynamic characteristics of contacts associated with the at least one of the graphical representations.

2. The device according to claim 1, wherein selection of graphical representations to be modified is based on user defined parameters, selectable via the CGUI.

3. The device according to claim 1, wherein rendering further includes arranging the control elements within the CGUI based on geographical locations of the one or more contacts.

4. The device according to claim 1, wherein rendering further includes rendering an image representative of a video clip in association with one or more of the control elements.

5. The device according to claim 1, wherein the control elements are arranged in a collage with each skin contiguous to neighboring skins.

6. The device according to claim 4, wherein each given image representative of a given video clip is a control element associated with the given video clip.

7. The device according to claim 1, wherein graphically modifying in brightness, contrast or focus includes modifying in brightness as a function of a first characteristic of the one or more dynamic characteristics of contacts associated with the at least one of the graphical representations and modifying in contrast or focus as a function of a second characteristic of the one or more dynamic characteristics of contacts associated with the at least one of the graphical representations, distinct from the first characteristic.

8. A communication device comprising:
a display; and
an interactive contact interfacing module adapted to:
(a) retrieve a list of contacts;
(b) retrieve data sets including data associated with one or more contacts of the list of contacts, wherein the data associated with each contact of the one or more contacts includes: (1) a contact title, (2) a contact graphical representation, and (3) an online status; and
(c) render upon said display a contact graphic user interface (CGUI) including control elements, each control element being associated with one of the one or more contacts, and each skinned with the graphical representation of the respective contact;
wherein said rendering includes graphically modifying in brightness graphical representations of contacts currently online.

9. The device according to claim 8, wherein rendering further includes arranging the control elements within the CGUI based on geographical locations of the one or more contacts.

10. The device according to claim 8, wherein rendering further includes rendering an image representative of a video clip in association with one or more of the control elements.

11. The device according to claim 8, wherein the control elements are arranged in a collage with each skin contiguous to neighboring skins.

12. The device according to claim 10, wherein each given image representative of a given video clip is a control element associated with the given video clip.

13. The device according to claim 8, further comprising modifying in contrast or focus at least one of the graphical representations as a function of one or more dynamic characteristics of contacts associated with the at least one of the graphical representations.

14. A method of generating contact graphical user interfaces (CGUI's), said method comprising:
retrieving a list of contacts from a data storage;
retrieving data sets including data associated with one or more contacts of the list of contacts, wherein the data associated with each contact of the one or more contacts includes: (1) a contact title, (2) a contact graphical representation, and (3) data indicative of one or more dynamic contact characteristics; and
rendering upon a display a contact graphic user interface (CGUI) including control elements, each control element being associated with one of the one or more contacts and skinned with the graphical representation of the respective contact;
wherein said rendering includes graphically modifying in brightness, contrast or focus at least one of the graphical representations as a function of one or more dynamic characteristics of contacts associated with the at least one of the graphical representations.

15. The method according to claim 14, wherein selection of graphical representations to be modified is based on user defined parameters, selectable via the CGUI.

16. The method according to claim 14, further comprising arranging the control elements within the CGUI based on geographical locations of the one or more contacts.

17. The method according to claim 14, further comprising rendering an image representative of a video clip in association with one or more of the control elements.

18. The method according to claim 14, further comprising arranging the control elements in a collage with each skin contiguous to neighboring skins.

19. The method according to claim 17, wherein each given image representative of a given video clip is a control element associated with the given video clip.

20. The method according to claim 14, wherein graphically modifying in brightness, contrast or focus includes modifying in brightness as a function of a first characteristic of the one or more dynamic characteristics of contacts associated with the at least one of the graphical representations and modifying in contrast or focus as a function of a second characteristic of the one or more dynamic characteristics of contacts associated with the at least one of the graphical representations, distinct from the first characteristic.
